(19) United States
(12) Patent Application Publication
(10) Pub. No.: US 2005/0241896 A1
(43) Pub. Date: Nov. 3, 2005

(54) Brake rotors with heat-resistant ceramic coatings

(76) Inventor: Gerald Martino, New Santon, PA (US)

Correspondence Address: DANIEL A SULLIVAN JR, 825 FIFTH AVE, STE. 214, NEW KENSINGTON, PA, 15068, US

(21) Appl. No.: 10/833,782

(22) Filed: Apr. 28, 2004

(51) Int. Cl. F16D 69/00

(52) U.S. Cl. 188/218 XL; 188/251 M

(57) ABSTRACT

Brake rotors whose characteristics allow for use in vehicles driven on streets, roads and highways, for road race applications or even for general racing and general driving, having a braking surface comprising zirconium oxide and chromium carbide.

### BACKGROUND OF THE INVENTION

1. Field of the Invention

The present invention generally relates to brake rotors for vehicles.

2. Background Information

This invention relates to the brake rotors described and claimed in my U.S. Pat. No. 5,901,818, which is incorporated herein in its entirety by reference, for the purpose of describing essential and/or non-essential material respectively necessary for, or supportive of, a full understanding of the subject matter of the invention.

### OBJECT OF THE INVENTION

It is an object of the present invention to provide brake rotors whose characteristics allow for use in vehicles driven on streets, roads and highways, for road race applications or even for general racing and general driving.

### SUMMARY OF THE INVENTION

The above object, among others, is achieved according to the present invention by a brake rotor having a braking surface comprising zirconium oxide and chromium carbide.

Building on this basic idea, the brake rotor may have the following additional features, singly or in combination:
the braking surface grades from all metal in a bond coat to the zirconium oxide and chromium carbide in a top coat;
the braking surface has a bond coat comprising nickel;
the bond coat further contains aluminum;
the top coat, or an intermediate coat, has a lesser amount of nickel and aluminum than the bond coat;
the braking surface has a top coat consisting essentially of 65 to 75 parts by weight zirconium oxide and 25 to 35 parts by weight chromium carbide.
the braking surface comprises:
a bond coat of about 4.5 wt.-% aluminum, 95.5 wt.-% nickel;
an intermediate coat of about 70 parts by weight zirconium oxide (yttria stabilized), 30 parts by weight of a composition as used for the bond coat (about 4.5 wt.-% aluminum, 95.5 wt.-% nickel), and 10 parts by weight chromium carbide; and
a top coat of about 70 parts zirconium oxide (yttria stabilized) and 30 parts by weight chromium carbide.
the braking surface is supported on a substrate of steel, titanium, or a titanium alloy.

### BRIEF DESCRIPTION OF THE DRAWINGS

The present invention will be more readily appreciated with reference to the accompanying drawings, in which:

FIG. 1 shows a plan view of a brake rotor according to the present invention;

FIG. 2 shows an elevational view of the brake rotor illustrated in FIG. 1;

FIG. 3 is a cross-section, taken along III-III of FIG. 1, which schematically illustrates different layers associated with a brake rotor according to the present invention; and

FIG. 4 illustrates a typical brake assembly employing a brake rotor according to the present invention.

### DESCRIPTION OF THE PREFERRED EMBODIMENTS

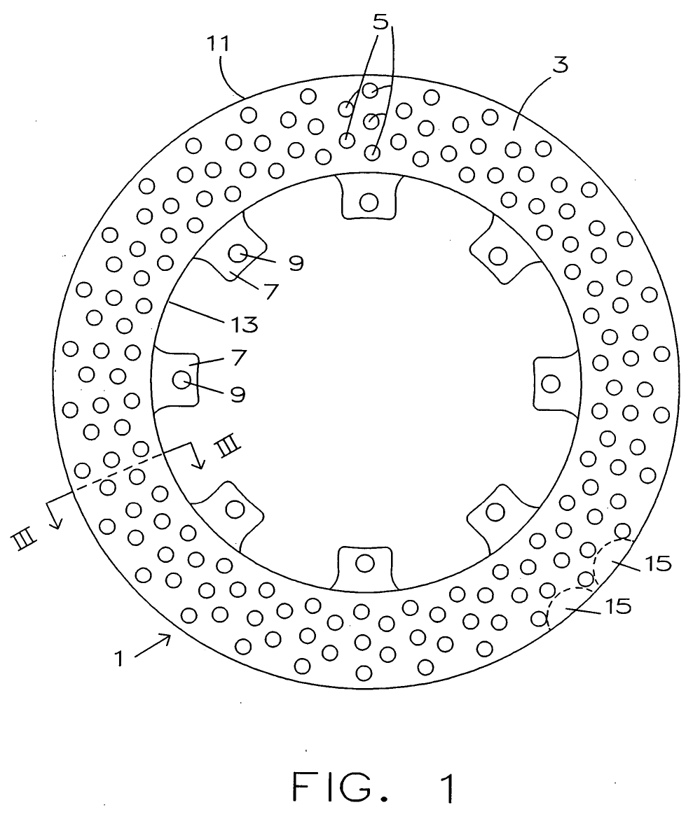

In accordance with a preferred embodiment of the present invention, as illustrated in FIG. 1, brake rotor 1 includes two opposite braking surfaces 3, one of which is shown in FIG. 1. The braking surfaces are oriented parallel to one another.

The rotor 1 has an outer peripheral surface 11 and an inner peripheral surface 13. The rotor has a series of holes 5 distributed on its braking surfaces and passing through the rotor, from one braking surface 3 on one side of the rotor, to the braking surface 3 on the other side of the rotor. A plurality of lugs 7 are arranged uniformly about the inner peripheral surface 13 of the rotor 1 and extend radially inwardly. Each lug 7 is appropriately provided with a hole 9 for connection with a hub member.

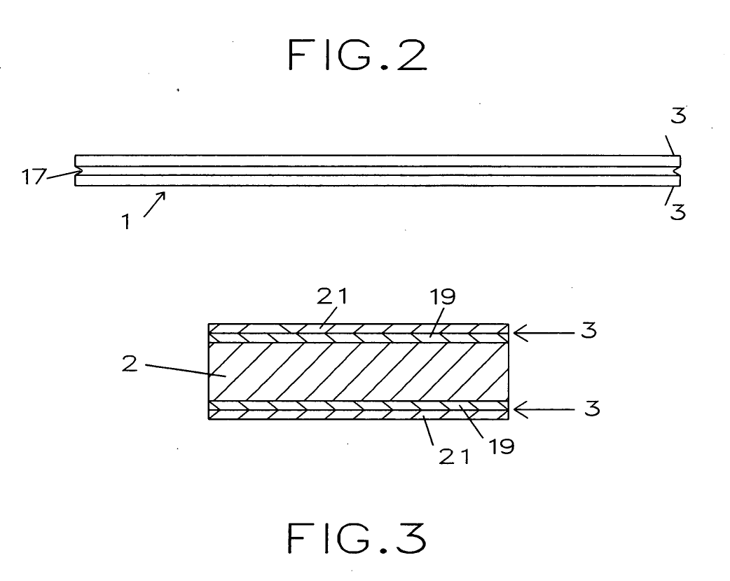

FIG. 2 is an elevational view of the brake rotor illustrated in FIG. 1. The outer peripheral surface 11 (see FIG. 1) of the rotor 1 is indented about substantially its entire circumference with a groove 17.

FIG. 3 provides a detailed, and essentially highly exaggerated, view of a cross-section of rotor 1, the cross-section being taken along line III-III of FIG. 1. As illustrated schematically in FIG. 3, rotor 1 is comprised of a substrate 2, which carries a braking surface 3 on each of its two broad sides. In the illustrated embodiment, each braking surface 3 is composed of two layers, which are referred to herein as “coats”. Thus, each braking surface is composed of a bond coat 19 and a top coat 21. The particular composition of these layers will be discussed more fully herebelow, as well as methods for applying the same to the braking surfaces 3. Generally, however, bond coat 19 may include a thin layer comprised of nickel, whilst the top coat 21 is a ceramic composition of zirconium oxide and chromium carbide, preferably in the range of 65 to 75 parts by weight zirconium oxide and 25 to 35 parts by weight chromium carbide. Preferably, bond coat 19 and top coat 21 will each have been applied to the braking surfaces 3 by plasma spraying techniques which are well known to those of ordinary skill in the art. Following application of the materials by plasma spraying, the braking surface is ground smooth.

As a general rule, increasing the chromium carbide relative to the zirconium oxide increases the wear resistance of the braking surface, while increasing the zirconium oxide relative to the chromium carbide increases the coefficient of friction of the braking surface.

Coatings composed of more than two layers may, of course, be used, and may even be preferred, for instance for the purpose of making transitions between different coefficients of thermal expansion less abrupt, or for the purpose of introducing various kinds of materials offering special advantages. The Example below, for instance, uses three layers, a bond coat, an intermediate coat, and a top coat.

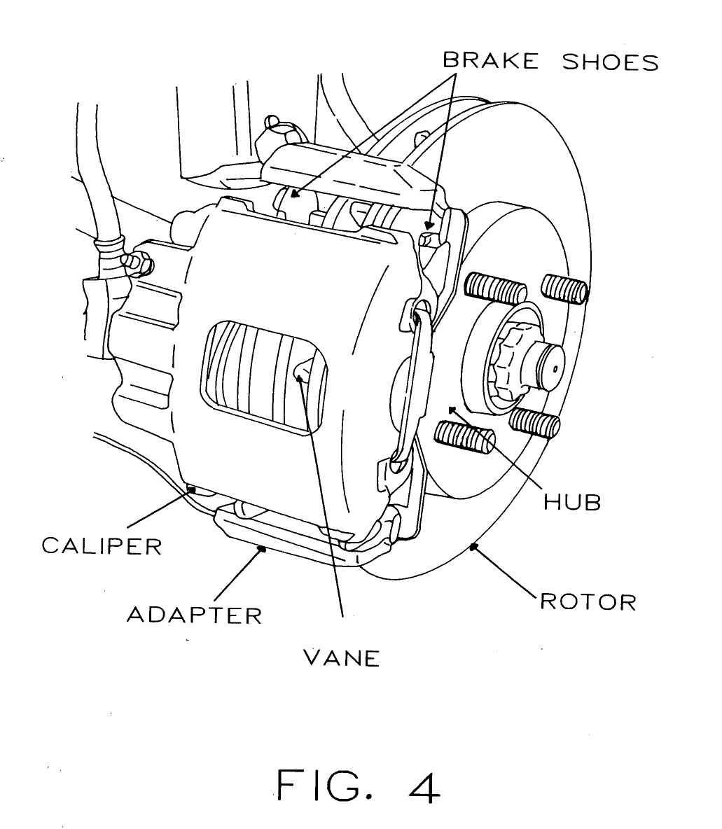

FIG. 4 illustrates a typical brake assembly in which a brake rotor according to the present invention may be employed. Various components of the brake assembly are indicated by name. It will be understood that the “brake shoes” may essentially be considered as including friction pads. Unlike the single-plane rotor of FIGS. 1 to 3, the rotor of FIG. 4 is a vaned rotor composed of two planes, each having an outwardly facing braking surface composed of coats, as described with reference to FIG. 3. The two planes are separated by inwardly situated vanes. The rotors of the invention may, or may not, have holes 5 in the braking surfaces, and, to illustrate this variation, the vaned rotor illustrated in FIG. 4 does not have holes 5. Vaned rotors may be manufactured using jigs to hold the vanes in place relative to the planes, followed by TIG welding of the vanes to the interior surfaces of the planes. Alternatively, vaned rotors may cast as one unit, using casting processes, such as investment casting.

Suitable materials for substrate 2 include titanium and titanium alloys, for instance A-90 Grade 2 essentially pure titanium, or the nominally 6 wt.-% aluminum, 4 wt.-% vanadium, titanium alloy, and alloy steel, for instance AISI 4130 chromium-molybdenum steel.

Further illustrative of the invention is the following

### EXAMPLE

The Example of my above-references U.S. Pat. No. 5,901,818 was varied in the following manner: For the intermediate coat, the 10 parts tungsten carbide was replaced by 10 parts chromium carbide; and, the top coat composition was 70 parts zirconium oxide (yttria stabilized) and 30 parts chromium carbide.

Vaned rotors prepared as described in the above Example were used on a 2003 Corvette with C-5 calipers from Red Devil Brakes, Mt. Pleasant, Pa. According to the Corvette Acceleration Specifications page on Chevrolet's website, all 3 models of the 2003 Corvette driving from 60 MPH to 0, stop at a distance of 125 fee. The ceramic coated titanium rotor of the invention stops in a 80 to 85 foot average for 60 MPH to 0.

The invention as described hereinabove in the context of the preferred embodiments is not to be taken as limited to all of the provided details thereof, since modifications and variations thereof may be made without departing from the spirit and scope of the invention.

1. A brake rotor having a braking surface comprising a bond coat containing nickel; an intermediate coat comprising zirconium oxide chromium carbide, and nickel; and a top coat comprising about 65 to 75 parts by weight zirconium oxide and about 25 to 35 parts by weight chromium carbide.

2. A brake rotor as claimed in claim 1, the braking surface grading from all metal in a said bond coat to the zirconium oxide and chromium carbide in a said top coat.

3. (canceled)

4. A brake rotor as claimed in claim 1, the bond coat further containing aluminum.

5. A brake rotor as claimed in claim 4, the top coat, or an intermediate coat, having a lesser amount of nickel and aluminum than the bond coat.

6. A brake rotor as claimed in claim 4, wherein the braking surface has a top coat consisting essentially of 65 to 75 parts by weight zirconium oxide and 25 to 35 parts by weight chromium carbide.

7. A brake rotor having a braking surface comprising:
a bond coat of about 4.5 wt.-% aluminum, 95.5 wt.-% nickel;
an intermediate coat of about 70 parts by weight zirconium oxide (yttria stabilized), 30 parts by weight of a composition as used for the bond coat (about 4.5 wt.-% aluminum, 95.5 wt.-% nickel, and 10 parts by weight chromium carbide; and
a top coat of about 70 parts zirconium oxide (yttria stabilized) and 30 parts by weight chromium carbide.

8. A brake rotor as claimed in claim 7, wherein the braking surface is supported on a substrate of steel, titanium, or a titanium alloy.

9. A brake rotor as claimed in claim 1, wherein the zirconium oxide in the top coat is yttria stabilized.

10. A brake rotor as claimed in claim 9, wherein the zirconium oxide in the intermediate coat is yttria stabilized.

11. A brake rotor as claimed in claim 1, wherein the braking surface is supported on a substrate of steel, titanium, or a titanium alloy.

12. A brake rotor as claimed in claim 1, wherein the braking surface is supported on a substrate comprising a titanium alloy.
